(19) United States
(12) Patent Application Publication
(10) Pub. No.: US 2020/0024867 A1
(43) Pub. Date: Jan. 23, 2020

(54) WIRELESS ELECTRIC LOCK CORE

(71) Applicant: Nexkey, Inc., San Mateo, CA (US)

(72) Inventors: Chi (Ricky) Lee, Emeryville, CA (US); William J. Rehlich, Emeryville, CA (US); Peter R. Russo, Oakland, CA (US)

(21) Appl. No.: 16/516,141

(22) Filed: Jul. 18, 2019

Related U.S. Application Data
(60) Provisional application No. 62/699,986, filed on Jul. 18, 2018.

(51) Int. Cl. E05B 47/06; E05B 47/00; G07C 9/00; G06F 8/65

(52) U.S. Cl. CPC E05B 47/063; E05B 47/0012; G07C 2009/0019; G06F 8/65; E05B 2047/0091; G07C 9/00182

(57) ABSTRACT

Various implementations of a wireless electric lock core are described that includes a face situated on a front side of a lock and configured to activate the lock responsive to a user touching the face, and a lock mechanism, and a housing including a power source, circuitry powered by the power source and coupled to the face, the circuitry being configured to authenticate a user, and electro-mechanically actuate the lock mechanism upon activation of the lock, and an antenna powered by the power source and coupled to the circuit, the antenna being situated at the front side of the lock behind the face and controlled by the circuitry to wirelessly communicate with a user device; and a rotor coupled to the circuitry and the lock mechanism, the rotor being powered by the power source and configured to actuate the lock mechanism based on commands from the circuitry.

### CROSS-REFERENCE TO RELATED APPLICATIONS

The present application claims the benefit under 35 U.S.C. § 119(e) of U.S. Provisional Patent Application Ser. No. 62/699,986, entitled “Wireless Electric Lock Core,” filed on Jul. 18, 2018, the entire contents of which are incorporated by reference.

### TECHNICAL FIELD

The present disclosure relates to lock mechanisms.

### BACKGROUND

Purely mechanical key-actuated locks are ubiquitously used in residential and commercial applications. As Internet-of-things (“TOT”) devices have gained popularity, and their component costs have decreased, people are considering replacing mechanical locks with electronic locks in commercial and residential applications due to the flexibility, ease of use, and other advantages that current electronic locks have over conventional mechanical ones. However, existing electronic locks have a number of issues preventing rapid and/or widespread adoption.

For instance, existing electronic locks are bulky/larger in size and/or are often difficult and expensive to install as a retrofit into existing doors. Existing electronic locks require a user to buy a whole lock set and are unable to swap out one or more pieces in order to work with pre-existing hardware. Further, existing electronic locks often require wired power sources (e.g., an alternating current (AC) feed), which may require complex installations, such as hiring an electrician to run the wiring.

Additionally, in general, factors that determine the specifications for the general shape and size of electronic circuitry of existing electronic locks have prevented the creation of very small electronic locks that are convenient to use in retrofit applications, and are smart (e.g., are wirelessly accessible and can perform computing functions), energy efficient, and low maintenance.

Depending on the application, such smart locks should also be capable of being weatherproof and tamperproof to prevent failure in extreme weather conditions, and provide robust security protection of the individuals and/or assets they are intended to secure.

### SUMMARY

A wireless electric lock core is described. One general aspect includes a face situated on a front side of a lock and configured to activate the lock responsive to a user touching the face; a lock mechanism; and a housing including a: a power source; circuitry powered by the power source and coupled to the face, the circuitry being configured to authenticate a user, and electro-mechanically actuate the lock mechanism upon activation of the lock; an antenna powered by the power source and coupled to the circuit, the antenna being situated at the front side of the lock behind the face and controlled by the circuitry to wirelessly communicate with a user device; and a rotor coupled to the circuitry and the lock mechanism, the rotor being powered by the power source and configured to actuate the lock mechanism based on commands from the circuitry.

Implementations may include one or more of the following features. The lock where activating the lock further includes transmitting an authentication request using a wireless signal from the antenna to a user device to confirm a user identity responsive to activating the lock. The lock where the authentication request includes a digital key transmission. The lock where the circuitry includes a processor configured to execute logic for electro-mechanically actuating the lock mechanism. The lock where the antenna is further configured to wirelessly communicate with a user device to receive firmware updates for the circuitry. The lock where the power source is replaceable via the front side of the lock by detaching the face to gain access to the power source. The lock where the lock is usable in retrofit applications. The lock where the face includes a touch-to-wake mechanism that activates the lock responsive to the user interacting with the touch-to-wake mechanism. The lock where the housing further includes a first profile that is configured to be positioned within a cavity of a cylinder and a first groove of the housing aligns with a second groove of the cylinder such that a lock pin extends through the second groove. The lock where the housing is configured to self-align with the cylinder. The lock where the lock pin is spring loaded. The lock where lock mechanism includes a bi-stable state and in a first state allows the locking mechanism to relock and a second state allows the locking mechanism to stay unlocked. The lock where the antenna is a low-power antenna and the low-power antenna is situated at the front side of the lock and directly behind the face with no other components between the low-power antenna and the face in order to reduce obstructing the low-power antenna. The lock where the housing further include: a first cavity in which the circuitry is seated; a second cavity in which the rotor is seated; and a third cavity in which the antenna is seated.

One general aspect includes a lock including an electronic unit installed into a casing of a lock, the electronic unit being configured to receive wireless commands; a rotor unit installed into a housing that is connected to the casing of the lock, the rotor unit being configured to be controlled by signals from the electronic unit; and a lock mechanism installed into a cylinder of the lock that is connected to the rotor unit, the rotor unit causing a flange that extends from the lock mechanism to rotate when the rotor unit is actuated.

Implementations may include one or more of the following features. The lock where the electronic unit includes an antenna configured to receive the wireless commands and a power source to power the electronic unit. The lock where the flange projects radially outward cylinder of the lock when the lock mechanism is in a locked state and the flange engages with a lock pin located within a groove of the flange. The lock where the rotor unit can cause the lock mechanism to perform an unlock motion that causes the lock pin to be pushed within a recess of the rotor unit and allows the lock mechanism to freely rotate. The lock where the rotor unit can cause the lock mechanism to perform a lock motion that causes the lock pin to be pushed up in order to restrict a motion of the lock mechanism.

One general aspect includes a method of lock actuation including touching a face of a lock in a locked state, where touching the face activates the lock for operation; wirelessly transmitting an authentication request to a user device by the lock, the authentication request triggering a response that confirms an identity of a user as an authorized user of the lock; and wirelessly receiving an authentication response from the user device by the lock, the authentication response electromechanically unlocking the lock.

### BRIEF DESCRIPTION OF THE DRAWINGS

FIGS. 1A-1G depict various views of an example electronic lock.

FIG. 2A depicts an exploded view of the electronic lock.

FIG. 2B shows the electronic unit and the circuitry of the rotor unit.

FIG. 2C shows a cutaway view of the electronic lock.

FIGS. 3A-3D show various views of the housing.

FIG. 4A shows a coupling of the housing to the cylinder.

FIG. 4B shows a coupling of the housing to the casing.

FIG. 5 is a shows an example view of the housing.

FIG. 6 is a flowchart of a method of lock actuation.

### DETAILED DESCRIPTION

The present disclosure relates to an innovative electronic lock, although it should be understood that the structure and acts described herein may be applicable to other lock form factors not described herein. The electronic lock may, in some embodiments, comprise a smart lock having enhanced features, such as wireless unlocking, cryptographic authentication, low power consumption, etc. The electronic lock may, in some cases, advantageously be a drop-in replacement/retrofit for a traditional lock (e.g., mortise lock). It may be a direct replacement for a mechanical lock cylinder (e.g., key in knob cylinder).

In some implementations, the form factor of the electronic lock may require a pocket to be cut into a door or other object (e.g., piece of furniture, etc.) into which the electronic lock is fitted. Other applications and suitable form factors are also possible and contemplated.

As described in this document, the electronic lock includes numerous features, such as, but not limited to; a face including a touch-to-wake mechanism that activates the electronic lock for operation when a user moves the face, the face being removable to seamlessly service the electronic unit of the electronic lock; a casing that self-aligns with a profile of the housing; an electronic unit including a power source (e.g., replaceable battery) and a wireless antenna; a lock mechanism enclosing another profile of the housing; circuitry (e.g., PCB) with at least one part being seatable within a first cavity of the rotor unit, the circuitry being capable of transferring power from the power source to a motor coupled to a rotor within a second cavity of the housing; a unique bi-stable configuration that allows the electronic lock to operate in a bi-stable fashion to advantageously allow the electronic lock to relock when needed, or stay open when needed; a lower profile; any suitable tail pieces or cams can be used/are supported; being tamperproof and weatherproof; a concavely-shaped subassembly that can accommodate adjacently situated electro-mechanical components of the electronic lock; and core cutouts and a sub-assembly component configuration that allow for secure pin retainment, movement of the pin, and for actuating pin/locking of lock. In some implementations, the lock may also include a breakaway feature that deters and/or prevents tampering and forced entry into the lock. For example, the breakaway portions of the lock may break when the lock is tampered with and the break may result in the lock being inaccessible to the tampering as a result of the breakaway portion. The breakaway portion may also be easily and cheaply replacable to reduce the effects of tampering on the lock.

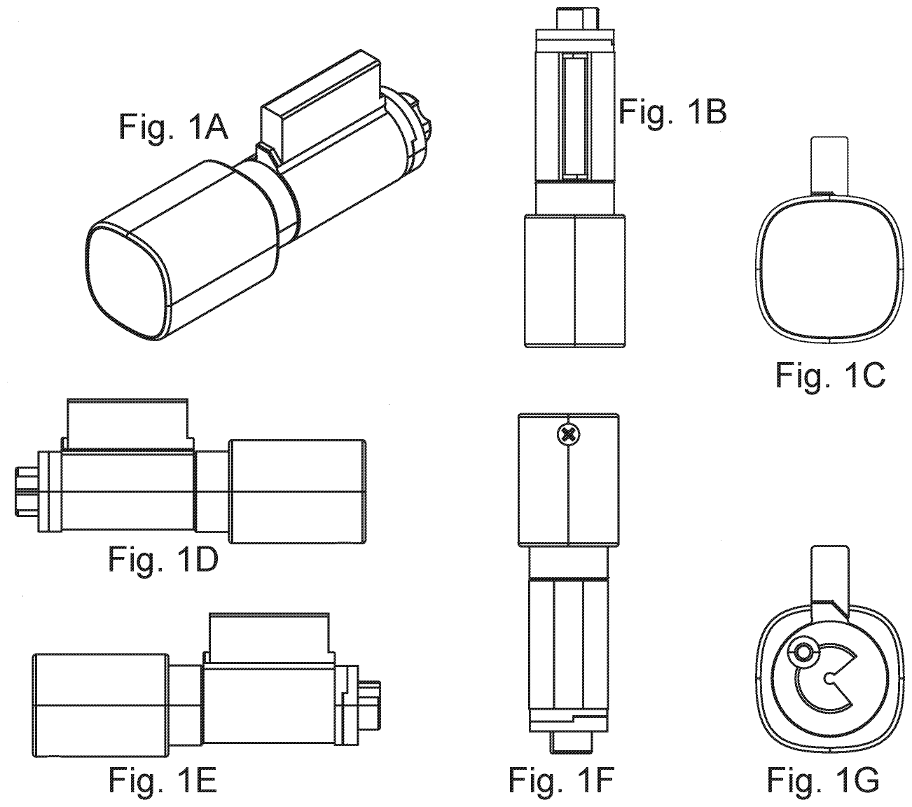

FIGS. 1A-1G depict various views of the electronic lock in an assembled state. FIGS. 1A and 1B respectively show a perspective view and a top view of the electronic lock in an assembled state. FIG. 1C illustrates a front view of the electronic lock while FIG. 1D shows a left-side view of the electronic lock. The right-side view of the electronic lock is shown in FIG. 1E. FIG. 1F shows the bottom view and FIG. 1G shows the back view of the electronic lock.

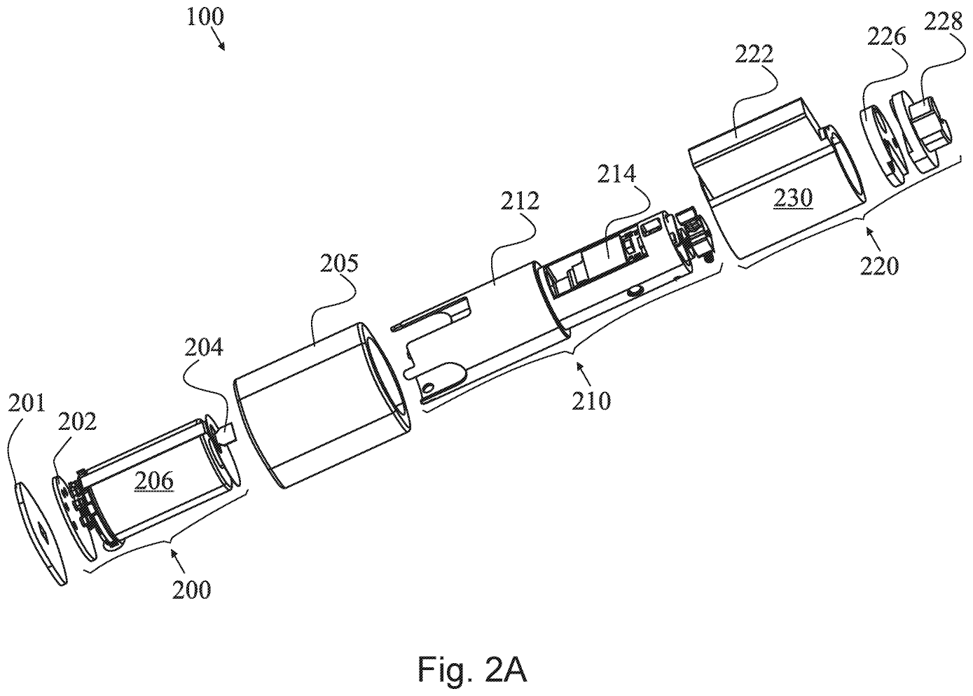

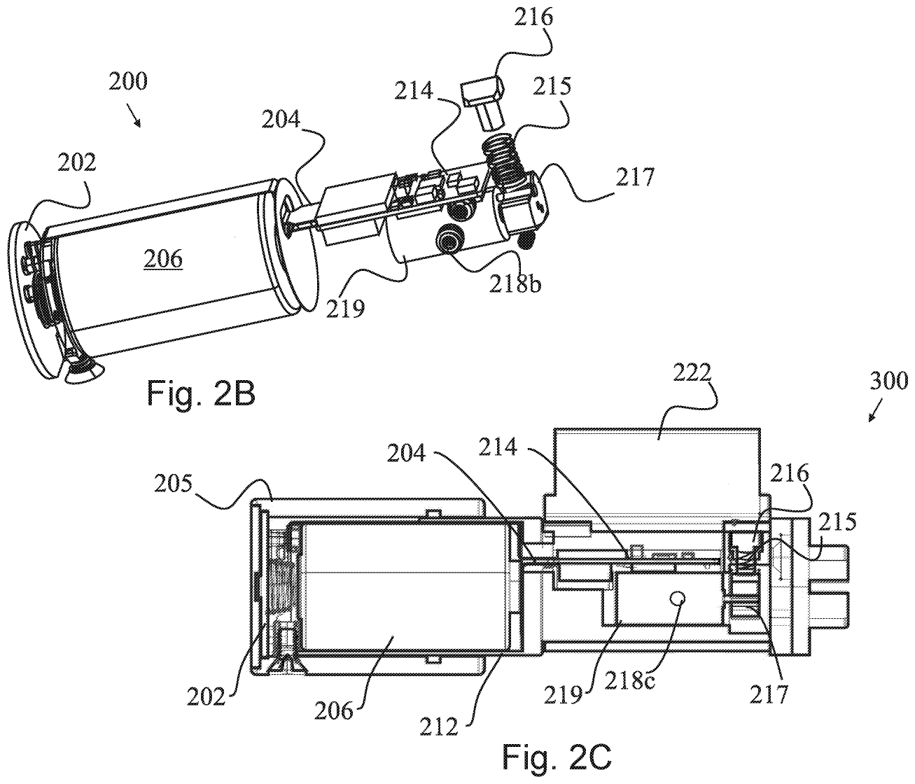

FIG. 2A depicts an exploded view of the internal components of the electronic lock 100. The electronic lock 100 includes an electronic unit 200, a rotor unit 210, and a lock mechanism 220. The electronic lock 100 may further include a face 201 that caps the front face of the electronic lock 100 and in some implementations may be intractable, such as including a touch-to-wake mechanism.

The face 201 may be engageable (e.g., touchable, pressable, tappable, etc.) by a user to wake up or activate the electronic lock 100. In some embodiments, the face 201 may be spring-loaded to allow it to be restored to its original state after a user engages (e.g., moves) it. Although engaging the face 201 may activate the electronic lock 100, it should be understood that other means for activating the electronic lock 100 such as voice activation, vibration activation, automatic schedule activation, etc., are also herein contemplated.

The electronic unit 200 may include an antenna 202 coupled to a power source 206. As shown, the antenna 202 may be separate from the circuitry 214, in which case, the two may be coupled together via one or more wires 204 or other suitable electronic couplings. In some embodiments, the antenna 202 and the circuitry 214 can be integrated together as a single unit.

The antenna 202 may, among other things, facilitate wireless communication between a user device (e.g., mobile device, server, personal computer, or the like) responsive to lock activation. For instance, the antenna 202 may wirelessly communicate with the user device via wireless communication protocols such as Bluetooth, Bluetooth for lower-powered devices (BLE), ZigBee, Z-wave, 6LoWPAN, Thread, Wi-Fi-ah/HaLow, WirelessHART, Wi-Fi, cellular (e.g., 3G, 4G, 5G, etc.) or other suitable wireless communication protocols. In some embodiments, the antenna 202 may be situated within specific locations within the electronic lock 100 to facilitate efficient communication between the electronic lock 100 and the user device. For instance, the antenna 202 may be positioned at the front side of the electronic lock 100 behind (e.g., abutting a backside, immediately behind the face, spaced a predetermined distance behind the face, etc.) the face 201 to prevent other components of the electronic lock 100 from obstructing the low power wireless signal transmitted to the user device. Such a configuration can allow low power antennas that do not unduly drain energy from the power source 206 to be incorporated into the current design.

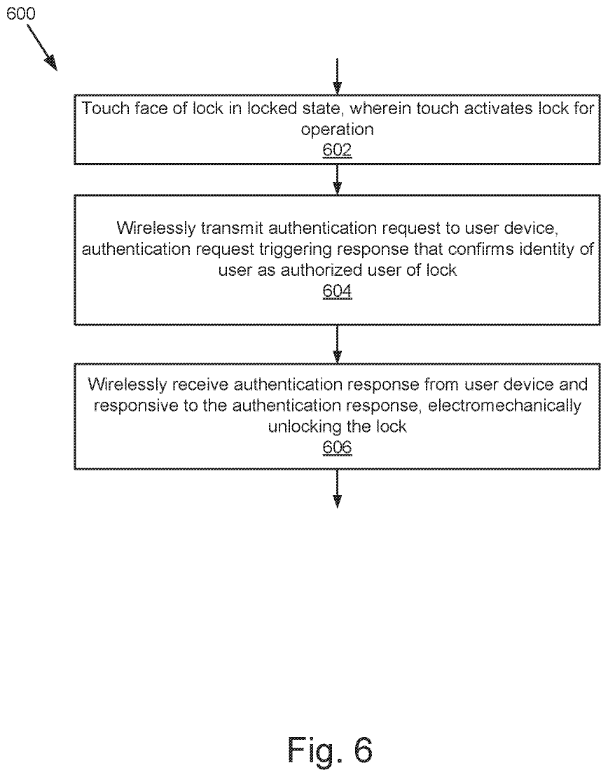

It should be understood that the communication between the antenna 202 and the user device may facilitate operations such as digital key transmissions between the electronic lock 100 and the user device, firmware updates of the electronic lock 100, data transmissions (e.g., notifications, status updates, error messages, etc.) between the electronic lock 100 and the user device, user authentication, among other things. In some cases, the antenna's operation may be primarily controlled by the circuitry 214. An example typical user authentication and unlocking of the electronic lock 100 in such instances may comprise: triggering a wireless authentication request by the circuit 214 which causes the antenna to transmit the authentication request to the user device; and receiving a wireless authentication response from the user device via the antenna 202 which the circuitry 214 uses to electro-mechanically unlock the electronic lock 100 responsive to confirming the user's identity as described in more detail with respect to FIG. 6.

FIG. 6 shows a flowchart 600 of an example method of lock actuation. At 602, a user may touch or interact with a lock in a locked state, such as by touching the face of the lock and the touch activates the lock for operation. At 602, the antenna may wirelessly transmit an authentication request to a user device response to the activation of the lock for operation. In some instances, the user device may be a predetermined device, while in further implementations, the user device may be transmitted to by the antenna based on a proximity to the antenna. In some implementations, the authentication request to the user device may trigger a response from the user device that confirms the identity of a user as an authorized user of the lock. In further implementations, if the identity of a user is not confirmed during the authentication request, then the lock may remain in a locked state. At 606, the lock may wirelessly receive the authentication response from the user device and responsive to the authentication response, a lock mechanism may electromechanically unlock the lock.

Turning back to FIG. 2A, the power source 206, which is shown as part of the electronic unit 200, may be a rechargeable battery, a nonchargeable battery, or some other modular power unit that can be coupled (e.g., in some cases seamlessly) to the electronic lock 100 without requiring extra wiring, and/or other AC power sources to provide electric power to the electronic lock 100. In some embodiments, the components of the electronic lock 100 requiring power (e.g., the antenna 202, the circuitry 214, and the motor 219, etc.) may be efficiently configured/optimized/conveniently structured/situated within the electronic lock 100 to conserve energy, thus allowing the electronic lock 100 to operate over extended periods of time (e.g. 5 years or more, 50,000 activations, other extended periods of time (e.g., measured in cycles, time, etc.) without having to recharge, service and/or replace the power source 206. In further implementations, the power source 206 may be in an arrangement that is easily removable to replace the power source 206, such as in a handle of the electronic lock 100.

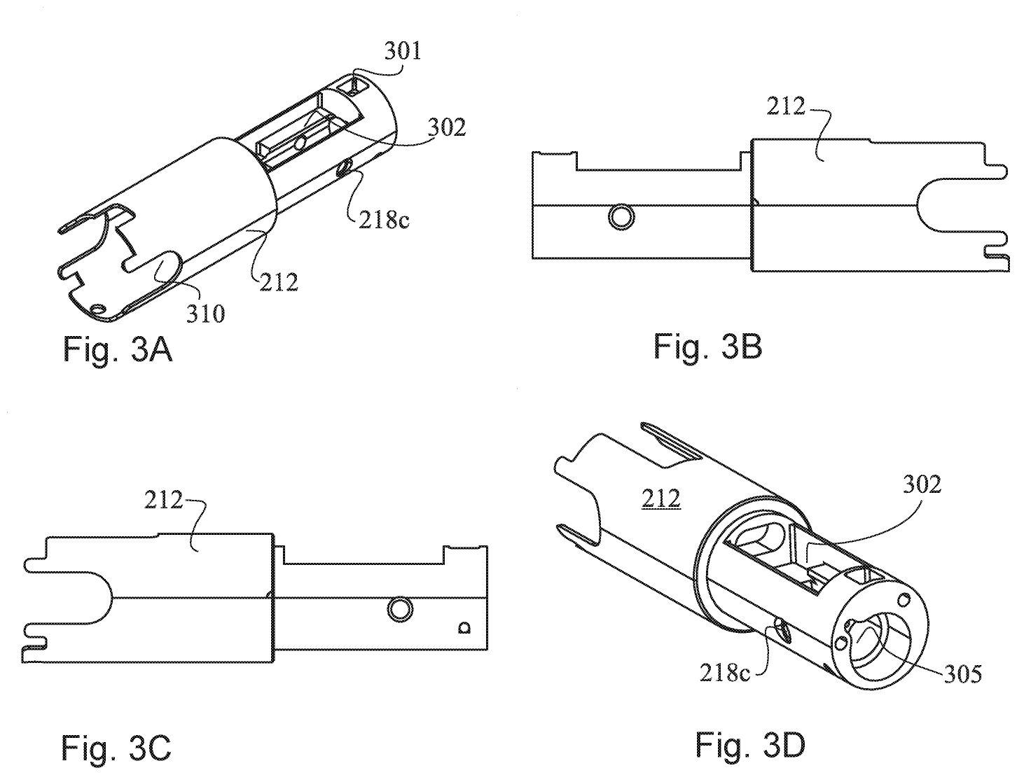

Also shown in FIG. 2A is the rotor unit 210. In some embodiments, the rotor unit 210 may include a housing 212 (also referred to as a casing) having one or more cavities into which other components of the electronic lock 100 may be fitted. For instance, the housing 212 may include a first cavity 302 (FIG. 3A) into which the circuitry 214 may be seated, a second cavity 305 (FIG. 3D) into which the motor 219 and rotor 217 shown in FIG. 2B may be fitted, and a third cavity 310 (FIG. 3A) into which part or all of the electronic unit 200 may be inserted.

FIG. 2A depicts an exploded view of a lock mechanism 220 which may include a flange 222 of a cylinder 230, and a cam adapter 226 coupled to the cam 228. In some embodiments, the cam adapter 226 may be compatible with other cams other than the cam 228. For instance, the cam adapter 226 may allow industry standard cams such as L Lock, Yale, Sargent, Corbin, Adams Rite, etc., to be incorporated into the present design in the absence of the cam 228.

The flange 222 may project radially outward from the cylinder 230 so that the motion of the rotor 217, which is regulated by the motor 219 coupled to the rotor 217 and controlled by the circuitry 214, can move a component of the rotor to move into a position in which the lock pin 216 is unlocked and free to move. The motion of the lock pin 216 controls the lock mechanism 220 of the electronic lock 100 as further discussed with reference to FIG. 2C.

FIG. 2B shows a coupling of the electronic unit 200 to circuitry 214 of the rotor unit 210. As shown in FIG. 2B, the electronic unit 200 may be coupled to the circuitry 214 via the one or more wires 204. The one or more wires 204 may be any suitable conductor plug/connector for coupling electrical devices. As shown, the circuitry 214 may in turn be coupled to the motor 219 which in turn is coupled to the rotor 217 via a motor shaft (not shown).

In some embodiments, the motor may be directly coupled to the circuitry 214 such that the coupling between the circuitry 214 and the motor 219 does not only facilitate the circuitry 214 controlling the motor 219 but also powers the motor 219. In other embodiments, the motor may have a separate signal line to the power source 206, in which case the circuit's connection to the motor 219 transmits control signals to the motor 219 from the circuitry 214 whiles the separate signal line powers the motor 219.

Also shown in FIG. 2B is a lock pin 216 (simply referred to as a spring-loaded lock pin 216) and a spring 215 which are configured to move within a groove of the flange 222. The spring-loaded lock pin 216 shown may extend into the flange 222 as shown in FIG. 2C.

The circuitry 214 shown in FIG. 2B may for example, include a printed circuit board (PCB) having logic for electro-mechanically controlling the operation of the electronic lock 100. This logic may reside on a non-transitory memory of the PCB and may be executed using a processor of the PCB. In some embodiments, the logic within the non-transitory memory may be updated using any suitable program update technique. For example, the logic may be updated wirelessly or using a wired connection to circuitry 214. In some embodiments, the circuitry 214 may be further coupled to an activation switch that activates the circuit 214 when a user moves the face 201 as described above with reference to FIG. 2A and FIG. 6. In other embodiments, the activation switch may be directly embedded within the circuit 214 to activate the circuit 214 when a user moves the face 201.

The circuitry 214 may control other components of the electronic lock 100. For instance, the circuitry 214 upon activation may cause the antenna 202 to wirelessly broadcast an authentication request to the user device to authenticate a user in order to unlock the electronic lock 100. The user device in turn may wirelessly transmit a second signal to the electronic lock 100 authorizing the electronic lock 100 to grant the user unlock access. Using the received data and/or unlock command, from the user via the antenna 202, the circuitry 214 may confirm the identity of the user. After confirming the identity of the user, the circuitry 214 may send lock actuation commands to the motor 219 which causes the motor 214 to turn the rotor 217. The motion of the rotor 217 allows the cylinder 230 to be able to fully rotate which causes the cam adapter 226 to move, which in turn, actuates the lock mechanism of the electronic lock 100.

FIG. 2C shows a cutaway view 300 of the electronic lock 100. In this figure, the spring-loaded lock pin 216 is shown as extending through a groove 301 (FIG. 3A) of the housing and further into a cavity of the flange 222. In one embodiment, the flange 222 may be in a static state such that the spring-loaded lock pin 216 may move (e.g., either up or down) in a bi-stable manner (i.e. move to illustrate one of a locked state and an unlocked state of the electronic lock 100) within the groove of the flange 222 to either unlock or lock the door to which the electronic lock 100 is coupled. For instance, an unlock motion of the rotor 217 can push the spring-loaded lock pin 216 further into the rotor unit 210 so that the cam adapter 228 may be allowed to freely rotate in order for the cam 228 to move from a locked position to an unlocked position. In another embodiment, a lock motion of the rotor 217 can cause the spring-loaded lock pin 216 to be pushed (e.g., pushed up) by the spring 215 in order to restrict the motion of the cam adapter 226 and thus cause the cam 228 to be positioned in a locked position.

The fastening groove 218c shown in FIG. 3C may be used to secure the motor 219 to the housing 212 using the fastener 218b (FIG. 2B). The other components shown in FIG. 2C are discussed with reference to FIGS. 2A and 2B.

FIGS. 3A-3D show various views of the housing 212. FIG. 3A depicts a first perspective view of the housing 212. As mentioned before, the housing 212 may have one or more cavities 302 (first cavity), 305 (second cavity depicted in FIG. 3D), and 310 (third cavity). The functions of these cavities are discussed with reference to FIG. 2A. Also shown in FIG. 3A are fastening groove 218c and groove 301 which are discussed with reference to FIG. 2C.

FIGS. 3B and 3C respectively depict a left-side view and a right-side view of the housing 212. In some implementations, the housing 212 may include two separate pieces connected by fasteners (not shown), such as where the larger portion of the housing 212 joins with the smaller portion. In some implementations, the fasteners may allow for a breakaway action where the housing 212 will separate at the fasteners when the housing 212 is placed under a torqued load. FIG. 3D shows a second perspective view of the housing 212 to illustrate the second cavity 305 mentioned earlier. The fastening groove 218c and the first cavity 302 are discussed above with reference to FIGS. 2A and 2C.

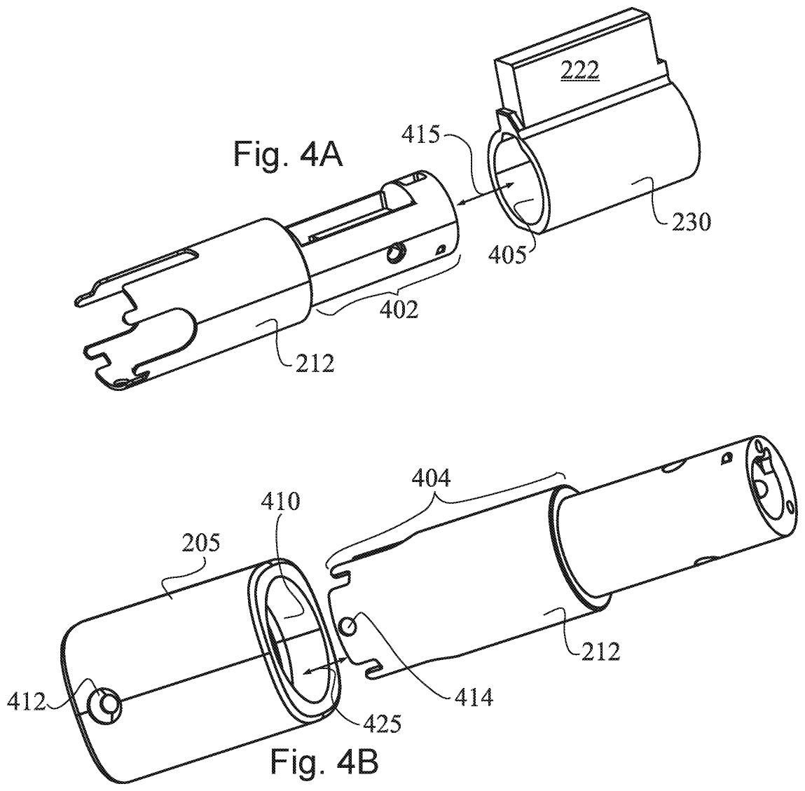

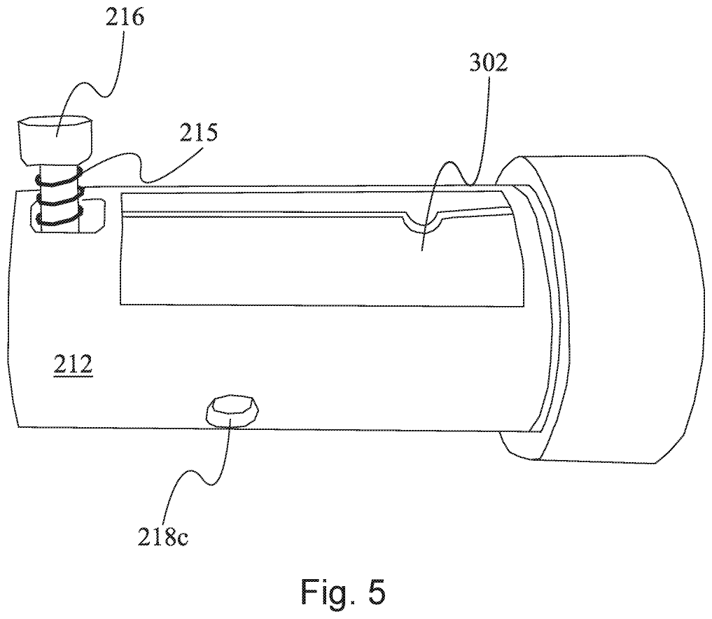

FIG. 4A shows a coupling of the housing 212 to the cylinder 230. In one embodiment, the cylinder 230 may be machined to have a cavity 405 into which a first profile 402 of the housing 212 can be seamlessly slid 415. Once the first profile 402 is slid into the cylinder 230, the groove 301 (FIG. 3A) aligns with a second groove (not shown) within the flange 222 of the cylinder 230 so that the spring-loaded lock pin 216 can extend through the groove 301 of the flange 222 as shown in FIG. 2C to cause the electronic lock to operate as discussed above. It should be understood that a specific implementation of the profiles are described herein and the profiles and/or cavities described herein may be different than this implementation in order to adapt to different lock configurations.

FIG. 4B shows a coupling of the housing 212 to the casing 405. In one embodiment, after fitting the electronic unit 200 into the third cavity 310 of the housing 212 as discussed with reference to FIG. 2A, a second profile 404 of the housing 212 may be slid 425 into the cavity 410 of the casing 205 such that fastening grooves 412 on the casing 205 and fastening groove 414 on the housing 212 are aligned. Once the fastening grooves 412 and 414 are aligned, a fastener (e.g., a screw) may be used to retain the housing 212 within the casing 205.

FIG. 5 is an example of the housing 212. In the example, the lock pin 216 is shown with the spring 215 around its lower profile. The example also shows the cavity 302 and the fastening groove 218c. The features shown in the picture are further described with reference to the descriptions provided for at least FIGS. 2A, 2B, 3A, and 3C above.

The foregoing description, for purposes of explanation, has been provided with reference to various embodiments and examples. However, the illustrative discussions above are not intended to be exhaustive or limited to the precise forms of the electronic lock 100 disclosed herein. Many modifications and variations are possible in view of the above teachings. The various embodiments and examples were chosen and described in order to best explain the principles upon which the design of the electronic lock 100 is based. Practical applications of the above concepts by one skilled in the art that utilize the above innovative technology with various modifications as may be suited to the particular use are contemplated.

What is claimed is:

1. A lock comprising:
a face situated on a front side of a lock and configured to activate the lock responsive to a user touching the face;
a lock mechanism; and
a housing including a:
a power source;
circuitry powered by the power source and coupled to the face, the circuitry being configured to authenticate a user, and electro-mechanically actuate the lock mechanism upon activation of the lock;
an antenna powered by the power source and coupled to the circuit, the antenna being situated at the front side of the lock behind the face and controlled by the circuitry to wirelessly communicate with a user device; and
a rotor coupled to the circuitry and the lock mechanism, the rotor being powered by the power source and configured to actuate the lock mechanism based on commands from the circuitry.

2. The lock of claim 1, wherein
activating the lock further comprises transmitting an authentication request using a wireless signal from the antenna to a user device to confirm a user identity responsive to activating the lock.

3. The lock of claim 2, wherein the authentication request includes a digital key transmission.

4. The lock of claim 1, wherein the circuitry includes a processor configured to execute logic for electro-mechanically actuating the lock mechanism.

5. The lock of claim 4, wherein the antenna is further configured to wirelessly communicate with a user device to receive firmware updates for the circuitry.

6. The lock of claim 1, wherein
the power source is replaceable via the front side of the lock by detaching the face to gain access to the power source.

7. The lock of claim 1, wherein
the lock is usable in retrofit applications.

8. The lock of claim 1, wherein the face includes a touch-to-wake mechanism that activates the lock responsive to the user interacting with the touch-to-wake mechanism.

9. The lock of claim 1, wherein the housing further comprises a first profile that is configured to be positioned within a cavity of a cylinder and a first groove of the housing aligns with a second groove of the cylinder such that a lock pin extends through the second groove.

10. The lock of claim 9, wherein the housing is configured to self-align with the cylinder.

11. The lock of claim 9, wherein the lock pin is spring loaded.

12. The lock of claim 1, wherein lock mechanism includes a bi-stable state and in a first state allows the locking mechanism to relock and a second state allows the locking mechanism to stay unlocked.

13. The lock of claim 1, wherein the antenna is a low-power antenna and the low-power antenna is situated at the front side of the lock and directly behind the face with no other components between the low-power antenna and the face in order to reduce obstructing the low-power antenna.

14. The lock of claim 1, wherein the housing further comprise:
a first cavity in which the circuitry is seated;
a second cavity in which the rotor is seated; and
a third cavity in which the antenna is seated.

15. A lock comprising:
an electronic unit installed into a casing of a lock, the electronic unit being configured to receive wireless commands;
a rotor unit installed into a housing that is connected to the casing of the lock, the rotor unit being configured to be controlled by signals from the electronic unit; and
a lock mechanism installed into a cylinder of the lock that is connected to the rotor unit, the rotor unit causing a flange that extends from the lock mechanism to rotate when the rotor unit is actuated.

16. The lock of claim 15, wherein the electronic unit includes an antenna configured to receive the wireless commands and a power source to power the electronic unit.

17. The lock of claim 15, wherein the flange projects radially outward cylinder of the lock when the lock mechanism is in a locked state and the flange engages with a lock pin located within a groove of the flange.

18. The lock of claim 17, wherein the rotor unit can cause the lock mechanism to perform an unlock motion that causes the lock pin to be pushed within a recess of the rotor unit and allows the lock mechanism to freely rotate.

19. The lock of claim 17, wherein the rotor unit can cause the lock mechanism to perform a lock motion that causes the lock pin to be pushed up in order to restrict a motion of the lock mechanism.

20. A method of lock actuation comprising:
touching a face of a lock in a locked state, wherein touching the face activates the lock for operation;
wirelessly transmitting an authentication request to a user device by the lock, the authentication request triggering a response that confirms an identity of a user as an authorized user of the lock; and
wirelessly receiving an authentication response from the user device by the lock, the authentication response electromechanically unlocking the lock.
